(19) United States
(12) Patent Application Publication
(10) Pub. No.: US 2008/0179117 A1
(43) Pub. Date: Jul. 31, 2008

(54) Adapter and Method for Connecting an Electric Motor to a Transmission Interface of Auto Body Part

(76) Inventor: Dieter Scheer, Buehlertal (DE)

Correspondence Address: MICHAEL J. STRIKER, 103 EAST NECK ROAD, HUNTINGTON, NY, 11743, US

(21) Appl. No.: 11/913,563

(22) PCT Filed: May 29, 2006
(86) PCT No.: PCT/EP2006/062655

§ 371 Date: Nov. 5, 2007

(30) Foreign Application Priority Data
Jun. 29, 2005 (DE) 10 2005 030 218.1

(51) Int. Cl. B60K 1/00; B60R 11/00

(52) U.S. Cl. 180/65.1

(57) ABSTRACT

The invention relates to an adapter element (10) and to a method for connecting an electric motor, which comprises a housing (14), to a transmission interface (48) of a bodywork part (50) in a motor vehicle. The adapter element (10) is annular-shaped and comprises radial recesses (18, 58, 78), which can be engaged in a radial manner in corresponding counter recesses (20, 60, 80) of the housing (14, 15), in such a manner that the adapter element (10) surrounds the housing (14, 15) about the drive axle (31) and is fixed in an axial manner and in a positive fit in relation to the housing (14, 15), and the adapter element (10) comprises means (44, 38, 42, 46) for axially connecting to the transmission interface (48).

### PRIOR ART

The invention relates to an adapter element and to a method for connecting an electric motor to a body part of a motor vehicle, as generically defined by the preambles to the independent claims.

In German Patent Disclosure DE 103 35 014 A1, a transmission drive unit for adjusting moving parts in the motor vehicle has become known that is fastened to a body part by means of screw-on domes. For attaching an identical transmission drive unit in various customer-specific screw-on patterns of the auto body, the fastening domes are located displaceably on the transmission drive unit, so that the screw-on points of the transmission drive unit can be varied to suit the customer-specific body part without having to modify the housing of the drive unit. Although this kind of fastening of the transmission drive unit is relatively variable, nevertheless upon its assembly, the screw-on domes have to be positioned in the correct way. Moreover, screwing or riveting operations and having to keep these connection means on hand make for a relatively complicated process step.

### ADVANTAGES OF THE INVENTION

The adapter element of the invention and the method of the invention for connecting an electric motor to the transmission interface of an auto body part having the characteristics of the independent claims have the advantage that by the use of the adapter element of the invention, a specific electric motor can be attached in the motor vehicle to suit many different customer-specific transmission interfaces. If the annular adapter element has radial structural features on its inside that can cooperate with corresponding counterpart elements of the electric motor, then the electric motor housing can always be embodied identically for many different transmission applications. As a result, the complicated process of structural changes and the attendant tool costs for producing the motor housing are eliminated. As a result, the pole pot of the electric motor, for instance, can always have a defined counterpart structural feature that engages a corresponding, always identical, structural feature of the various adapter elements.

By the characteristics recited in the dependent claims, advantageous refinements of the apparatus and method of the independent claims are possible. If the radial structural feature of the adapter element is for instance embodied as a radially inward-extending extension, then it can engage a highly economically made recess (for instance by stamping) in the housing of the electric motor. As a result, the adapter element is fixed axially in form-locking fashion on the housing of the electric motor.

In an alternative embodiment, the adapter element has at least one radial recess, which is engaged by a correspondingly shaped radial extension on the housing of the electric motor. The radial extension can for instance be integrally formed onto the pole pot, and the pole pot is for instance made as a deep-drawn part.

If the radial structural feature of the adapter element has, in addition to the corresponding counterpart structural feature of the housing, a form lock in the circumferential direction, then the adapter element is secured against relative rotation with the electric motor without any additional process step.

In a preferred embodiment, the adapter element has two shell-like adapter parts, which in the put-together state form a circular recess, in which the housing, which is preferably approximately tubular, of the electric motor is received. Through this circular recess, the drive torque can be transmitted through a power takeoff element to the transmission interface.

It is especially favorable to produce the two adapter parts as identical components, since then a second tool for producing a second adapter part can be dispensed with, as can keeping an additional component in stock and furnishing it. The two identical adapter parts are joined together by connecting means upon the assembly on the electric motor. The connecting means can be embodied either as detent elements integrally formed onto the adapter parts, or as separate connecting means.

To reduce the number of parts, in a preferred embodiment two or more joining parts are joined together by means of hinges. Thus the one-piece adapter element can be placed radially around the electric motor and closed, using a further connecting means. In particular, when for instance there are two adapter parts, the first sleevelike connecting means can be preassembled, and the second connecting means can be introduced into the corresponding holes in the joining parts upon the assembly of the adapter elements.

It is especially advantageous if the connecting means are embodied as sleeves that serve to receive fastening elements, with which the adapter element is fastened axially to the transmission interface of the auto body part.

In an alternative embodiment, the adapter element is embodied in one piece as a resilient retaining bracket, which can be thrust by its open end radially onto the housing of the electric motor. In the process, the two resilient legs fit with their radial structural features into the corresponding counterpart structural features of the housing in form-locking fashion.

In such an embodiment, the adapter element, in at least one axial end, has stop faces, which after the assembly of the housing brace a previously assembled auto body part axially against the housing.

In an alternative embodiment, between its resilient legs the spring element has a region to which the spring element can be fastened axially at the transmission interface by means of fastening elements.

The adapter element is especially suitable for a transmission drive unit according to the invention, in which an electric motor has a standardized housing with a geometry (counterpart structural features) that is embodied as constantly the same and that cooperates with the radial structural features, also embodied constantly the same of the adapter element. The attachment of the adapter element to the transmission interface is embodied customer-specifically, so that it can be connected to various customer-specific transmission interfaces of a body part. Such an adapter for the transmission drive unit of the invention can be used for instance as a temporary way of attaining the objective, as long as the customer interfaces on the auto body do not yet have a uniform connection geometry. After that, the radial structural features of the adapter element can be embodied directly on the transmission interface of the body part, so that over the long term, the adapter element can be dispensed with.

In the method of the invention, the adapter element can be mounted very simply radially on the housing of the electric motor, and then the adapter element can be axially flanged to the transmission interface. As a result, the axial assembly process on the part of the customer can be made uniform, even for different structural features of the electric motor housing. By embodying the connecting means as receptacles for the fastening elements, the separate integral forming or installation of receptacles is advantageously dispensed with.

In an alternative method for attaching the electric motor to the body part, the body part is first place axially against the housing, and then the adapter element, embodied as a spring element, is slipped radially onto the housing. The structural features embodied on the adapter element radially engage corresponding counterpart structural features of the housing, thus forming an axial form lock between the adapter element and the housing. As a result, the body part is braced axially against the housing via an axial stop face of the adapter element.

### DRAWINGS

In the drawings, various exemplary embodiments of the adapter element according to the invention of the transmission drive unit are shown and described in further detail in the ensuing description.

FIG. 1 shows a view of a two-part adapter element that is preassembled on the electric motor;

FIG. 2 shows the same exemplary embodiment as FIG. 1, in which different radial structural features are schematically shown;

FIG. 3 shows a hingelike adapter element of FIG. 1 before it is mounted on the electric motor; and

FIG. 4 shows a further exemplary embodiment of an adapter element mounted on an electric motor.

### DESCRIPTION OF THE EXEMPLARY EMBODIMENTS

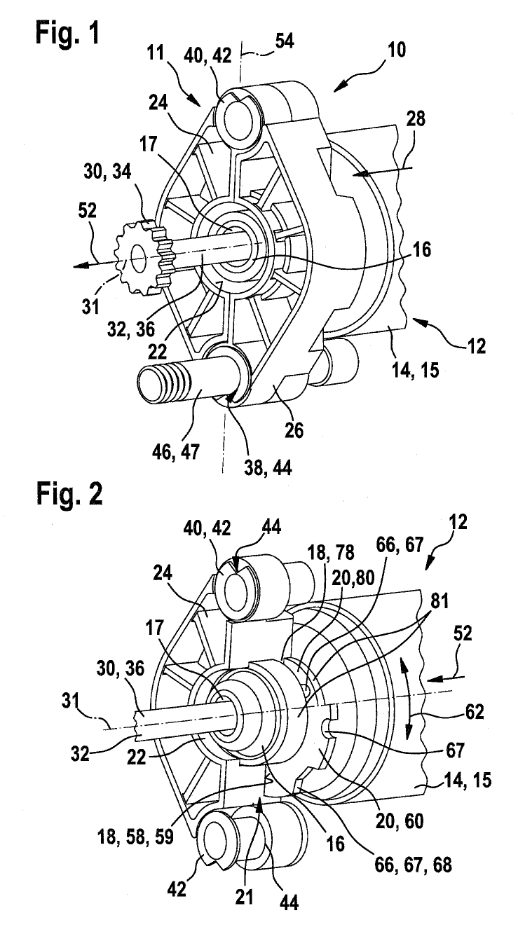

In FIG. 1, an adapter element 10 is shown, which is mounted on a housing 14 of an electric motor 12. The housing 14 is made of metal, in particular as a deep-drawn part, for instance as a pole housing 15. On an axial end 16, the housing 14 has a radial counterpart structural feature 20, which is engaged in form-locking fashion by a radial structural feature 18 that is integrally formed onto an inside face 22 of the adapter element 10. As can also be seen in FIG. 2, the adapter element 10 has two adapter parts 24, 26, which are both embodied in shell form. If these two joining parts 24, 26 are put together in the radial direction 28, the inside face 22 forms a circular recess, into which the end 16 of the housing 14, or a power takeoff element 30 protruding from it, is placed. The power takeoff element 30 is located on a power takeoff axis 31, which extends in the axial direction 52, and is embodied for instance as a power takeoff shaft 32, with a power takeoff pinion 34 located on it. Alternatively, a flexible shaft 36 can engage an opening 17 in the housing 14 of the electric motor 12. The two adapter parts 24 and 26 are joined together by means of connecting elements 40. The connecting elements 40 are embodied here as sleeves 42, which are inserted into corresponding holes 44 in the two adapter parts 24, 26. In the assembled state, the adapter element 10 completely surrounds the approximately tubular housing 14. The radial structural features 18 together with the counterpart structural features 20 of the housing 14 form an axial form lock 21, so that the adapter element 10 that has been joined together is solidly fixed on the electric motor 12. Fastening means 46, by means of which the adapter element 10 can be fastened in the axial direction 52 to a transmission interface 48, not shown in further detail, of a motor vehicle, can be introduced into the sleevelike connecting elements 40, 42. The fastening means 46 are for instance embodied as screws 47 or rivets, which are received in the connecting means 40 and are correspondingly fastened in the axial direction 52 to a body part 50 of the transmission interface 48. In FIG. 1, the two adapter parts 24 and 26 are embodied identically, so that they are symmetrical perpendicular to a parting line 54 between the two adapter parts 24 and 26. The adapter parts 24, 26 are embodied as plastic injection-molded parts and are joined together by means of metal sleeves 42. As a result, a dimensionally stable, wear-resistant receptacle 38 for the fastening means 46 is created.

In FIG. 2, for the sake of illustration, only one adapter part 24 and two different axial form locks 21, the latter shown schematically, are shown along with the housing 14. In the lower half of the drawing, on its inner face 22, the adapter element 10 has, as a radial structural feature 18, a recess 58 which is embodied as a radial groove 59 extending all the way around. This radial recess 58 is engaged by a radial rib 60 as a counterpart structural feature 20 of the housing, and this extends radially outward. In this exemplary embodiment, both the radial recess 58 and the radial rib 60 are embodied extending all the way around the entire circumference 62. In other embodiments, the structural features 18 and the corresponding counterpart structural feature 20 may also be limited to defined angular ranges. In this way, a form lock 66 with regard to the circumferential direction 62 is also realized that represents a torsion preventer 67 of the adapter 10 with regard to the electric motor 12. In FIG. 2, the torsion preventer 67, 66 is embodied by the radial notches 18 in both the radial rib 60 of the housing 14 and the corresponding radial recesses 58 of the adapter element 10.

In the upper half of the drawing, an alternative embodiment of the adapter element 10 is shown, which as a radial structural feature 18 has a radially inward-extending rib 78 that engages a radial counterpart structural feature 20 of the housing 14 embodied as a corresponding groove 80 extending all the way around. Such a groove 80 may for be cut out—in particular stamped out—from a wall 18 of the housing 14 or pressed into the housing 14. Inside the radial groove 80, a form lock 66 with regard to the circumferential direction 62 is again embodied, which prevents rotation of the adapter element 10 relative to the housing 14. In this embodiment, on its end 16, the housing 14 has the axial opening 17, into which for instance a flexible shaft 36 form-lockingly engages the power takeoff shaft 32.

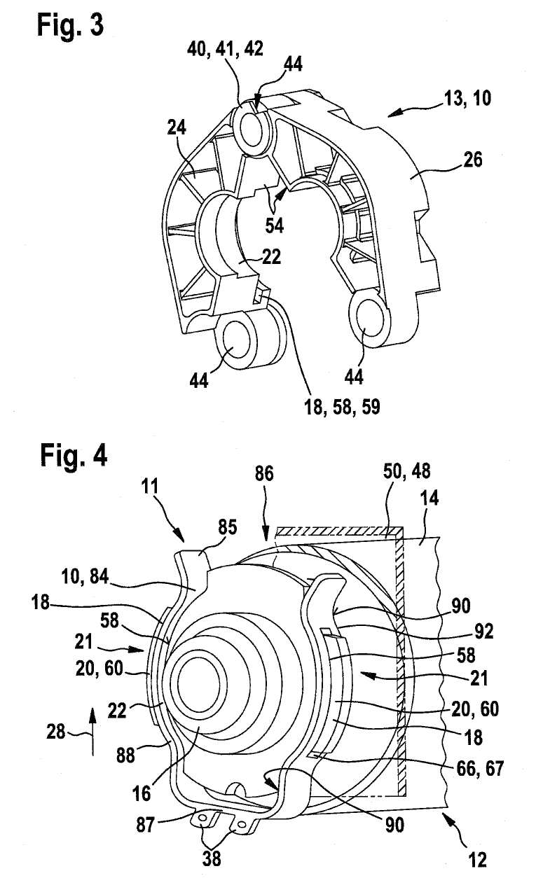

In FIG. 3, the adapter element 10 of FIG. 1 is shown before it is mounted onto the electric motor 10; the two half-shell-like joining parts 24 and 26 are each joined at one end in hingelike fashion to one another by a connecting means 40. The first connecting means 40 functions as a hinge bolt 41, on which the two adapter parts 24 and 26 are supported rotatably counter to one another. The hinge bolt 41 is for instance embodied as a sleeve 42, as in FIGS. 1 and 2, that is inserted into the holes 44 in the adapter parts 24, 26. For assembly, this one-piece adapter element 10 is slipped like a cuff 13 radially over the radial counterpart structural features 20, 60 of the housing 14, causing them to engage the radial recesses 18, 58 in the adapter element 10. After that, the cuff 13 is closed by introducing a second connecting element 40 into the joining parts 24, 26. As a result, the adapter element 10, which for instance comprises two identical joining parts 24, 26, is solidly fixed on the electric motor 12.

In FIG. 4, the adapter element 10 is embodied as a one-piece retaining bracket 84, which is made for instance from spring steel 85. The adapter element 10 is U-shaped, with an open end 86 by which the adapter element 10 is slipped in the radial direction 28 onto the housing 24. The retaining bracket 84 has two resilient legs 88, which after the radial assembly rest resiliently radially on the housing 14. As radial structural features 18, radial recesses 58 are cut out of the adapter element 10 and are engaged by the radial ribs 60, as a counterpart structural feature 20 of the housing 14. Once again in one piece with the adapter element 10, receptacles 38 for fastening elements 46, with which the adapter 10 fixed on the electric motor 12 can be secured to the transmission interface 48, are integrally formed with the adapter element in a bracketlike region 87 between the two legs 88.

In a variation of the exemplary embodiment, the retaining bracket 84 has axial stop faces 90, which press a previously axially mounted body part 50 axially against a further stop 92 of the housing 14. In this variant, the body part 50 with the transmission interface 48 is first slipped onto the housing 14 of the electric motor 12, in such a way that the body part 50 rests axially between the counterpart structural feature 20 and the stop 92 of the housing 14. Next, the adapter element 10 is slipped in the radial direction 28 onto the housing 14, whereupon the radial structural features 18 of the retaining bracket 84 engage the corresponding counterpart structural features 20 of the housing 14. In the radial assembly of the adapter element 10 embodied as a retaining bracket 84, the body part 50 is braced by the stop face 90 of the adapter element 10 against a corresponding stop 92 of the electric motor 12, and as a result the body part 50 is securely joined to the electric motor 12. The transmission interface 48 is located on the body part 50 in such a way that the power takeoff element 30 of the electric motor 12 is joined to the customer transmission of the transmission interface 48 as a transmission drive unit 11.

In an alternative embodiment, the retaining bracket 84 is embodied with wirelike legs, instead of the leaf-springlike legs 88. These wirelike legs at the same time form radial structural features 18, which correspond to the radial ribs 78 and engage a corresponding groove 80 or recess 80 in the housing 10. The wirelike legs likewise form an axial stop face 90, which presses the body part 50 against the housing 14.

It should be noted that with regard to the exemplary embodiments shown in the drawings and described, manifold combinations of the various characteristics with one another are possible. For instance, the concrete design of the radial structural features 18 with the corresponding counterpart structural features 20 can be varied arbitrarily; the form lock 66 embodied on these structural features 18 and counterpart structural features 20 can likewise be varied arbitrarily with regard to the circumferential direction 62 (or torsion preventer 67). Both the two-part and the one-piece adapter element 10 is mounted in each case in the radial direction 28 on the corresponding counterpart structural feature 20 of the housing 14. The attachment of the adapter element 10 in the axial direction 52 can be embodied with many kinds of connection techniques known in the prior art. The fastening means can also be embodied in one piece with the adapter element 10. Preferably, the adapter element 10 of the invention is used for attaching seat adjusting drives 12 to the adjusting mechanism 50, but may also be employed for other adjusting drives in the motor vehicle.

1. An adapter element (10) for connecting an electric motor (12), which has a housing (14, 15), to a transmission interface (48) of a body part (50) in a motor vehicle, wherein the adapter element (10) is embodied annularly and has radial structural features (18, 58, 78), which are capable of radially engaging corresponding counterpart structural features (20, 60, 80) of the housing (14, 15), in such a way that the adapter element (10) surrounds the housing (14, 15) about a power takeoff axis (31) and is axially fixed in form-locking fashion relative to the housing (14, 15), and the adapter element (10) has means (44, 38, 42, 46) for axial attachment to the transmission interface (48).

2. The adapter element (10) as defined by claim 1, characterized in that the radial structural features (18, 58, 78) of the adapter element (10) are embodied as a radial rib (78), which extends radially inward and is capable of engaging the inside of a corresponding radial groove (80) of the housing (14, 15).

3. The adapter element (10) as defined by claim 1, characterized in that the radial structural features (18, 58, 78) of the adapter element (10) are embodied as a radial recess (58, 59), which is capable of being engaged by a radially outward-extending rib (60) of the housing (14, 15).

4. The adapter element (10) as defined by claim 1, characterized in that the radial structural features (18, 58, 78) of the adapter element (10) have an internal profile (68), with respect to its circumferential direction (62), which profile, after the radial assembly onto the housing (14, 15), forms a form-locking torsion preventer (66, 67) with a corresponding counterpart profile (68) of the housing (14, 15).

5. The adapter element (10) as defined by claim 1, characterized in that the adapter element (10) has two semicircular joining parts (24, 26), which after the radial assembly onto the housing (14, 15) can be joined together by means of two connecting elements (40, 42), in particular.

6. The adapter element (10) as defined by claim 1, characterized in that the joining parts (24, 26) are embodied identically and in particular can be joined together by means of separate, sleevelike connecting means (42).

7. The adapter element (10) as defined by claim 1, characterized in that the semicircular joining parts (24, 26) are joined together in hingelike fashion, in particular by means of the sleevelike connecting means (40, 42).

8. The adapter element (10) as defined by claim 1, characterized in that the connecting means (40, 42) are embodied as receptacles (38) for fastening elements (46) for the axial assembly onto the transmission interface (48).

9. The adapter element (10) as defined by claim 1, characterized by its embodiment as a one-piece, U-shaped retaining element (84), which is made in particular from spring steel (85).

10. The adapter element (10) as defined by claim 1, characterized in that the adapter element (10) has axial stop faces (90), which after the assembly of the adapter element (10) are suitable for pressing the body part (50) axially against the housing (14, 15).

11. The adapter element (10) as defined by claim 1, characterized in that the retaining element has a bracketlike region (87), on which receptacles (38) for fastening elements (46) for the axial assembly onto the transmission interface (48) are embodied.

12. A transmission drive unit (11), having an electric motor (12) that has a housing (14)—in particular a pole housing (15)—which is fastened to a transmission interface (48) of a body part (50) by means of an adapter element (10) as defined by claim 1.

13. A method for connecting an electric motor (12) by means of an adapter element (10) to a transmission interface (48) of a body part (50), in particular as defined by claim 1, characterized by the following steps:
the adapter element (10) is mounted radially onto the electric motor (12) in such a way that the radial structural features (18, 58, 78) of the adapter element (10) engage corresponding counterpart structural features (20, 60, 80) of the electric motor (12) and form an axial form lock (21);
the adapter element (10) is placed axially against the transmission interface (48) of the body part (50) in such a way that a power takeoff element (30, 34, 36) of the electric motor (12) passes through the annular adapter element (10) to engage the transmission interface (48);
the adapter element (10) is fixed to the body part (50) by fastening means (46), which engage the receptacles (44, 38) of the adapter element (10).

14. A method for connecting an electric motor (12) by means of an adapter element (10) to a transmission interface (48) of a body part (50), in particular as defined by claim 1, characterized by the following steps:
the electric motor (12) is axially placed with an axial stop (92) against the body part (50) in such a way that the power takeoff element (30, 32, 34, 36) of the electric motor (12) engages the transmission interface (48);
the adapter element (10) is mounted radially on the housing (14, 15) of the electric motor (12), and the radial structural features (18, 58, 78) of the adapter element (10) engage corresponding counterpart structural features (20, 60, 80) of the electric motor (12) and form an axial form lock (21), and the adapter element (10) braces the body part (50) against the housing (14, 15) with an axial stop face (90).
